(19) United States
(12) Patent Application Publication
(10) Pub. No.: US 2008/0042434 A1
(43) Pub. Date: Feb. 21, 2008

(54) Device for Connecting a High Pressure Fuel Tube

(76) Inventor: Thomas Peter Kenny, Celletes (FR)

Correspondence Address: JACOBSON HOLMAN PLLC, 400 SEVENTH STREET N.W., SUITE 600, WASHINGTON, DC, 20004, US

(21) Appl. No.: 11/630,859

(22) PCT Filed: Jun. 24, 2005
(86) PCT No.: PCT/FR05/01592

§ 371 Date: Sep. 25, 2007

(30) Foreign Application Priority Data
Jun. 25, 2004 (FR) 0407016

(51) Int. Cl. F16L 19/02

(52) U.S. Cl. 285/354

(57) ABSTRACT

The inventive device comprises an intermediate part disposed in a junction (15) fixed to a common rail (2) at each connection (4) which is arranged in a wall (2a) and comprises a conical flare (5) whose base is oriented towards the outside of said rail (2) and comprises a connector (9) which is provided with an internal channel (12) is arranged in the junction (15) and whose top end (10) interacts with the end (7) of the tube (1) and whose low end (11) interacts with said conical flare (5). The inventive device also comprises a nut (16) consisting of a flange (19) whose external edge is extended by a skirt (20) and retained on the corresponding end of the tube (1) by the collar (8a) of a bulge (8) provided therewith and interacting with the junction (15), wherein the diameter of said junction (15) is substantially greater than the external diameter of the connector (9). Said invention can be used for thermal engines.

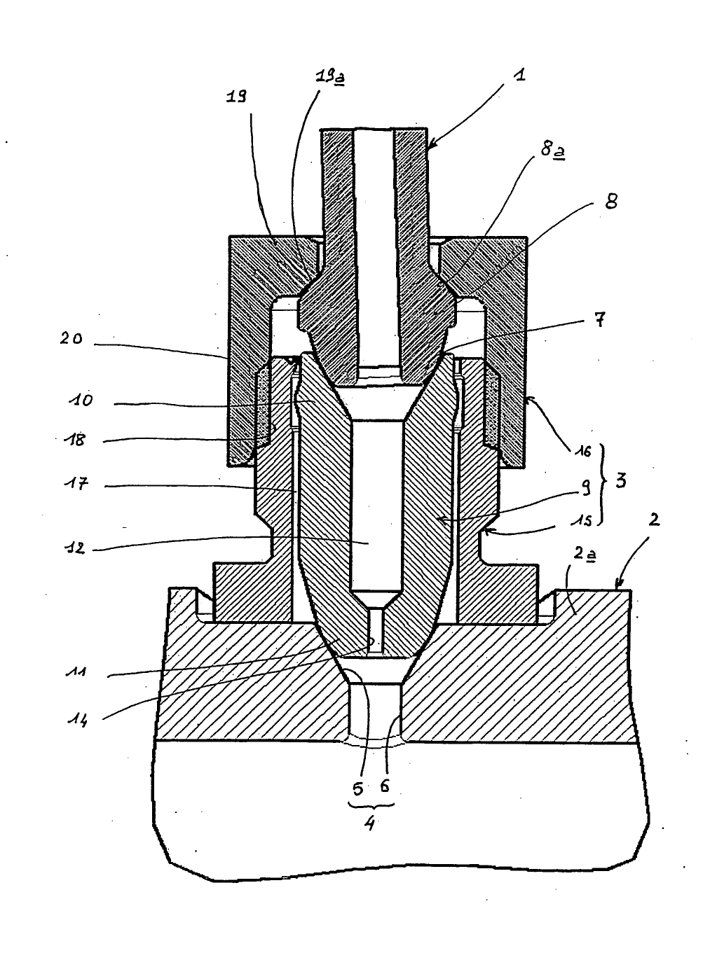

The invention relates to a device for producing a connection between a high-pressure fuel tube and a common rail of a fuel-injection system for a thermal engine.

In a common-rail injection system, a high-pressure pump sends pressurised fuel through an injection tube to this common rail, which acts as a pressure accumulator and a distributor to tubes which lead the pressurised fuel up to the injectors.

The high-pressure fuel tubes are connected either directly to the body of the rail, by contact of the tube end piece on the rail, or via an intermediate part known as a connector.

The system involving an intermediate part operates like a conventional high-pressure hydraulic connection. A revolving hollow intermediate part is guided over its external diameter inside a threaded fitting. The tightening of a nut:generates a tension which is transmitted by the intermediate part. The two ends of the intermediate part then each produce a seal, one on contact with the tube and the other on contact with the fitting.

Document U.S. Pat. No. 6,609,502-B describes an improvement for a common-rail injection system of this type comprising an intermediate part arranged in a fitting located at each connection of the common rail; this part has the general shape of a hollow cylinder with two conical ends cooperating with corresponding surfaces arranged at the end of the high-pressure tube and the connection of the common rail. Moreover, the fitting comprises an external thread which cooperates with the internal thread of a nut in such a way that the high-pressure tube is clamped by its free end against the intermediate part which is, in turn, clamped against the common rail.

The tube can therefore not be fitted at an inclination relative to the intermediate part, thus disadvantageously leading to poor contact of the sealing surfaces and therefore a risk of leakage.

The intermediate part and the rail are tightly connected by the pressing of a conical formation at the end of the intermediate part against a conical receptacle of the rail body. The intermediate part can therefore not be inclined relative to the rail, so there is a risk of leakage. Its external diameter therefore has to be guided with precision by the internal diameter of the welded fitting. It also has to be centred with high precision relative to the axis of the conical receptacle on the rail body, also resulting in poor contact of the sealing surfaces and therefore leakage. The fitting which guides and centres the intermediate part also has to be perfectly concentric with the axis of the conical receptacle of the rail.

During tightening of the nut of the tube, the pressure of the tube on the intermediate part slightly deforms the external diameter of this part. In the case of precise centring and guiding between the intermediate part and the welded fitting, this increase in diameter of the intermediate part causes the part to become stuck in the fitting as soon as tightening commences: free sliding of the intermediate part is no longer ensured and the contact tension between the intermediate part and the rail body is lowered, resulting in a risk of leakage.

It is therefore one of the aims of the present invention to provide an improved device for producing a connection between a high-pressure tube and a common rail of a fuel-injection system for a thermal engine, which device eliminates the foregoing drawbacks and, more especially, allows conicity and/or concentricity defects to be accommodated.

Another aim of the invention is to provide a device of this type allowing simple and inexpensive integration of a calibrated carburettor jet required in certain injection systems.

An additional aim of the invention is to provide a device of this type which can be mass-produced inexpensively and is simple to manufacture and fit.

These aims, and also others which will become apparent hereinafter, are addressed by a device for producing a connection between a high-pressure fuel tube and a common rail of a fuel-injection system for a thermal engine, of the type comprising an intermediate part arranged in a fitting integral with the common rail at each connection which is provided in its wall and comprises a conical flare, the base of which is turned toward the exterior of the rail, and which comprises, on the one hand, a connector which comprises an inner channel, which is arranged in the fitting and the upper end of which cooperates with the end of the tube and the lower end of which cooperates with the conical flare, and, on the other hand, a nut which comprises a flange, the outer edge of which is extended by a skirt, and is retained at the corresponding end of the tube by the shoulder of a bulge provided therewith and cooperates with the fitting, which device is characterised, in accordance with the present invention, by the fact that the internal diameter of the fitting is substantially greater than the external diameter of the connector, over the entire length thereof, allowing the connector to be inclined with constantly optimum sealing contact between said connector and the rail.

Advantageously, the bulge is spherical in shape and the lower portion of the free edge of the flange of the nut is conical.

Preferably, the inner channel comprises, at its end directed toward the high-pressure tube, a conical flare and the end of the tube is spherical.

Advantageously, the lower end of the connector is spherical.

Preferably, the inner channel of the connector comprises a nozzle.

The following non-restrictive description is to be read with reference to the single appended FIGURE, which is a vertical section of a device for producing a connection between a high-pressure fuel tube and a common rail of a fuel-injection system for a thermal engine in accordance with the present invention.

In order to define words such as “upper”, “lower”, “outer” and “inner”, the device in accordance with the invention will be considered as oriented in the single FIGURE.

A device for producing a connection between a high-pressure fuel tube 1 and a common rail 2 of a fuel-injection system for a thermal engine consists, more especially, of an intermediate part denoted in its entirety by reference numeral 3.

The common rail 2 comprises on its wall 2a, preferably on the same generatrix, connections 4 allowing communication between the exterior of this rail and the interior thereof.

Each connection 4 comprises a conical receptacle 5, the base of which is turned toward the exterior of the rail and the peak of which is extended by a conduit 6 opening into the interior of this rail 2.

The high-pressure tube 1 comprises at its spherical end 7, directed toward the connection 4, a bulge 8. This bulge is generally spherical in shape: the upper shoulder 8a thus formed is convex in shape.

The intermediate part 3 comprises, on the one hand, a connector 9 and, on the other hand, means for joining said connector to the high-pressure tube 1 and the rail 2.

The connector 9 is a revolving hollow part, the upper end 10 of which cooperates with the end 7 of the high-pressure tube 1 and the lower end 11 of which cooperates with the conical receptacle 5 of the rail 2, and which comprises an inner channel 12.

The inner channel 12 comprises, at the end directed toward the high-pressure tube 1, a conical flare 13. It can also comprise a carburettor jet 14 which may open, as in the present embodiment, directly into the conical receptacle 5.

The lower end 11 of the connector 9 is spherical in shape and rests against the conical receptacle 5 of the rail 2: this produces not only a tight connection in this region but also a ball-and-socket connection allowing the connector 9 to be freely inclined with constantly optimum sealing contact between said connector and the rail 2.

At the upper end 10 of the connector 9, the conical flare 13 of the inner channel 12 cooperates with the spherical lower end 7 of the high-pressure tube 1: this produces, in this region, a ball-and-socket connection allowing the high-pressure tube 1 to be freely inclined with constantly optimum sealing contact between said high-pressure tube and the connector 9.

The means for joining the connector 9 to the high-pressure tube 1 and the rail 2 comprise a fitting 15 and a screw 16.

The fitting 15 is a revolving part containing a wide axial conduit 17 for accommodating the connector 9. The diameter of this axial conduit 17, or the internal diameter of the fitting 15, is greater than that of the connector 9 over the entire length thereof, in such a way that there is clearance between these two parts when they are fitted. This clearance will allow at all times optimum contact between the end 11 of the connector 9 and the connection 4 of the rail 4, however the connector is inclined.

This inclination is necessitated by the concentricity defects, on the one hand, between the fitting 15 and the conical receptacle 5 formed in the body of the rail 2 and, on the other hand, between the various contacts of the fitting 15/nut 16/tube 1/connector 9 assembly.

This fitting 15 is provided with an external thread 18 toward its upper portion, and it is welded to the rail 2.

The nut 16 comprises a flange 19 extended by an internally threaded skirt 20. The flange 19 cooperates with the bulge 8. The lower portion 19a of the free edge of the flange 19 is conical in shape and cooperates with the upper shoulder 8a of the spherical bulge 8.

The internal thread of the skirt 20 cooperates with the external thread 18 of the fitting 15.

In order to connect the high-pressure to tube 1 to the common rail 2 comprising connections such as the connection 4 illustrated in the single FIGURE, a fitting 15 is welded in such a way that its axis of vertical symmetry is substantially combined with that of the connection.

There is then arranged within this fitting 15 a connector 9, the spherical lower end 11 of which is accommodated in the conical receptacle 5. Moreover, as a result of the fact that the external diameter of the connector 9 is smaller, over the entire length thereof, than the internal diameter of the fitting 15, the curvature of the surfaces in contact allows substantially vertical positioning of the connector without the need for human intervention.

There is then arranged the high-pressure tube 1 provided with the nut 16, said nut being retained by its flange 19 on the bulge 8, and the nut 16 is screwed to the fitting 15: owing to the pressure exerted by the concave face 19a on the convex shoulder. 8a, the high-pressure tube 1 is positioned coaxially with the connection 4 and the connector 9.

The connector 9 is, as a person skilled in the art will be able to establish, made from a harder material than the other parts forming the connecting device in accordance with the present invention. The connector 9 is accordingly subject to zero, or at most negligible, deformation.

1. Connection device between a high pressure fuel line (1) and a common rail (2) of a fuel injection system for a heat engine, of the type comprising an intermediate part that is placed in a coupling (15) integral with said common rail (2) at each tap (4) made in its wall (2a) and comprises a conical flaring (5) the base of which is turned toward the exterior of said rail (2), and which comprises, on the one hand, a connector (9) which includes an internal channel (12) that is made in said coupling (15), and the upper end (10) of which cooperates with the end (7) of said fuel line (1) and the lower end (11) of which cooperates with said conical flaring (5), and on the other hand, a nut (16) composed of a flange (19) the outer edge of which is extended by a skirt (20) and is held at the corresponding end of said fuel line (1) by the shoulder (8a) of a bulge (8) that said shoulder has, and cooperates with said coupling (15), characterized by the fact that the inside diameter of said coupling (15) is appreciably greater than the outside diameter of said connector (9) along the full length of said connector (9), and that said connector (9) is secured in position by the pressure exerted by the fuel line (1) on it when the nut (16) is tightened on said coupling (15).

2. Connection device according to claim 1, characterized by the fact that the bulge (8) is spherical in shape and that the lower part of the free edge (19a) of the flange (19) of the nut (16) is conical.

3. Connection device according to claim 1 characterized by the fact that the internal channel (12) comprises, at its end pointed toward the high pressure line (1) a conical flaring (13) and that the end (7) of said line (1) is spherical.

4. Connection device according to claim 1, characterized by the fact that that the lower end (11) of the connector (9) is spherical.

5. Connection device according to claim 1, characterized by the fact that the internal channel (12) of the connector (9) includes a nozzle (14).
